(19) United States
(12) Patent Application Publication
(10) Pub. No.: US 2007/0140752 A1
(43) Pub. Date: Jun. 21, 2007

(54) FIXING APPARATUS AND IMAGE FORMING APPARATUS USING SAME

(76) Inventors: Shin Yamamoto, Ohsaka (JP); Masahiro Yagi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/610,124

(22) Filed: Dec. 13, 2006

(30) Foreign Application Priority Data
Dec. 20, 2005 (JP) 2005-366414 (JP)

(51) Int. Cl. G03G 15/20

(52) U.S. Cl. 399/323

(57) ABSTRACT

The present invention provides a fixing apparatus which effectively prevents a recording medium from coiling around the surface of a fixing member and also prevents damage to the surface of the fixing member, and an image forming apparatus comprising this fixing apparatus. A gap between the tip end of separating means and the fixing member can be managed appropriately, and as a result, the recording medium can be prevented from coiling around the surface of the fixing member. A spacer is mounted near the tip end of a separating claw, and the spacer contacts a protruding portion of a core metal of a fixing roller. Thus, a gap having a predetermined magnitude is formed between the tip end of the separating claw and the peripheral surface of the fixing roller. The gap is maintained by the spacer, and therefore the gap between the fixing roller and the separating claw can be managed appropriately over the long term. Moreover, paper can be prevented from coiling around the surface of the fixing roller by managing the gap appropriately, and since a contact member contacting the surface (fixing surface) of the fixing roller is not provided, the surface of the fixing roller is not damaged.

### BACKGROUND OF THE INVENTION

1. Field of the Invention

The present invention relates to an image forming apparatus such as a copier, a printer, or a facsimile apparatus, and more particularly to a fixing apparatus capable of preventing a recording medium from coiling around the surface of a fixing member as the recording medium passes through a nip portion formed between the fixing member and a pressure member.

2. Description of the Background Art

An electrophotographic system image forming apparatus such as a copier performs image formation in which an electrostatic latent image formed on a carrier such as a photosensitive drum is developed by a developing apparatus, whereupon the resulting toner image is transferred onto a recording medium and fixed by a fixing apparatus. Various systems have been proposed in the background art to serve as the fixing apparatus, but a typical, widely used heat fixing apparatus employs a heat roller system in which a pressure roller is pressed against the outer periphery of a fixing roller having an internal heater, whereupon a recording medium carrying an unfixed toner image is passed through a nip portion formed by the two rollers such that the toner image is fixed by the application of heat and pressure. A belt fixing apparatus, in which an endless-type fixing belt is wrapped around a heat roller and a fixing roller, and a pressure roller is pressed against the fixing roller from an outer peripheral surface of the fixing belt, is also known.

In this type of heat fixing apparatus, a problem arises in that the unfixed toner carried on the recording medium melts in the nip portion formed by the fixing member and pressure member as the recording medium passes through the nip portion, and the melted toner acts as an adhesive, causing the recording medium to coil around the surface of the fixing member as it is discharged from the nip portion, instead of separating from the surface of the fixing member.

Further, in a color image forming apparatus for forming full color images, a plurality of toner images in different colors are superposed onto the recording medium, and the resulting superposed toner image is fixed by the fixing apparatus. Therefore, a problem arises in that a large amount of toner melts in the nip portion, leading to an increase in the adhesive strength of the toner such that the recording medium coils around the fixing member with particular ease.

In consideration of these problems in a conventional fixing apparatus, a device for preventing a recording medium from coiling around a fixing member has been proposed (see Japanese Unexamined Patent Application Publication 2004-109636, for example). In this device, separating means such as a separating claw, a separating plate, or a separating sheet are brought into contact with the surface of a fixing roller, and as the recording material is discharged from a nip portion, the recording material is forcibly separated from the surface of the fixing roller by the separating means and thereby prevented from coiling around the surface of the fixing member. However, when the separating means are in constant contact with the fixing roller, the surface of the fixing roller may be damaged by the separating means. When the surface of the fixing roller is damaged, a new problem arises in that a track mark corresponding to the damage is formed on the toner image that passes through the nip portion, and as a result, the image quality of the fixed toner image deteriorates.

Hence, a fixing apparatus in which the tip end of the separating means is removed from the surface of the fixing roller has been proposed in Japanese Unexamined Patent Application Publication H6-149114 and so on. In this fixing apparatus, a contact member is provided on the tip end of a separating claw of the separating means such that the contact member contacts the peripheral surface of the fixing roller. As a result, a gap (an interval) is formed between the tip end of the separating claw and the surface of the fixing roller so that the tip end of the separating claw can be separated from the surface of the fixing roller.

However, the contact member contacts the peripheral surface of the fixing roller, and therefore the surface of the fixing roller may be damaged.

Furthermore, it is not easy to set the interval between the tip end of the separating claw and the fixing member to a correct value, and the correct value may vary according to the machine model, the thickness of the recording medium passing through the nip portion, and the stiffness of the recording medium. Hence, the only method of determining the correct value of the interval is a process of trial and error for each machine model, and even when the correct value has been set, it may be impossible to prevent coiling effectively due to differences in the material and thickness of the recording material and the effects of static electricity.

With color toner in particular, the part of the toner image that is peeled away from the fixing member by the separating means after coiling around and becoming adsorbed to the fixing member increases in gloss, and therefore gloss unevenness between this part and the other parts of the toner image occurs easily.

Technologies relating to the present invention are also disclosed in, e.g. Japanese Unexamined Patent Application Publication H01-036200, Japanese Unexamined Patent Application Publication 2001-027862, Japanese Unexamined Patent Application Publication 2003-050479, Japanese Unexamined Patent Application Publication 2003-140486, and Japanese Unexamined Patent Application Publication 2004-233966.

### SUMMARY OF THE INVENTION

An object of the present invention is to provide a fixing apparatus that effectively prevents a recording medium from coiling around the surface of a fixing member and does not damage the surface of the fixing member, and an image forming apparatus comprising the fixing apparatus.

In an aspect of the present invention, a fixing apparatus has a fixing member that is heated by a heat source and a pressure member that is pressed against the fixing member. A recording material carrying an unfixed image is passed between the fixing member and the pressure member to fix the unfixed image on the recording material. The fixing apparatus further comprises a separating device for separating the recording material from the fixing member following fixing. The separating device comprises a separating member and a spacer attached to the separating member. A gap between the separating member and the fixing member is maintained by bringing the spacer into contact with a structural body of the fixing member.

In another aspect of the present invention, an image image forming apparatus comprises a fixing apparatus having a fixing member that is heated by a heat source and a pressure member that is pressed against the fixing member. A recording material carrying an unfixed image is passed between the fixing member and the pressure member to fix the unfixed image on the recording material. The fixing apparatus further comprises a separating device for separating the recording material from the fixing member following fixing. The separating device comprises a separating member and a spacer attached to the separating member. A gap between the separating member and the fixing member is maintained by bringing the spacer into contact with a structural body of the fixing member.

In another aspect of the present invention, an image forming method causes a recording material to carry an image formed by a toner containing at least a resin, a coloring agent, and a wax, and fixing the toner image carried on the recording material onto the recording material using a fixing apparatus. The fixing apparatus comprises a fixing member that is heated by a heat source and a pressure member that is pressed against the fixing member, and fixes an unfixed image on the recording material carrying the unfixed image by passing the recording material between the fixing member and the pressure member. The fixing apparatus further comprises a separating device for separating the recording material from the fixing member following fixing. The separating device comprises a separating member and a spacer attached to the separating member. A gap between the separating member and the fixing member is maintained by bringing the spacer into contact with a structural body of the fixing member.

### BRIEF DESCRIPTION OF THE DRAWINGS

The above and other objects, features, and advantages of the present invention will become more apparent from the following detailed description taken with the accompanying drawings, in which:

FIG. 1 is a view showing the schematic structure of the main parts of an example of a conventional fixing apparatus;

FIG. 2 is a sectional view showing the structure of the main parts of a first embodiment of the fixing apparatus according to the present invention;

FIG. 3 is a view showing in detail the structure around a tip end portion of a separating member of the fixing apparatus;

FIG. 4 is a sectional view showing the structure of the main parts of a second embodiment of the fixing apparatus according to the present invention;

FIG. 5 is a sectional view showing the structure of the main parts of a third embodiment of the fixing apparatus according to the present invention;

FIG. 6 is a view showing an example of separating means having a contact member and the structure around a tip end portion thereof; and

FIG. 7 is a sectional view showing the schematic structure of an example of an image forming apparatus to which the fixing apparatus according to each embodiment of the present invention can be applied.

### DESCRIPTION OF THE PREFERRED EMBODIMENTS

Before describing embodiments of the present invention, the background art and the problems contained therein will be described.

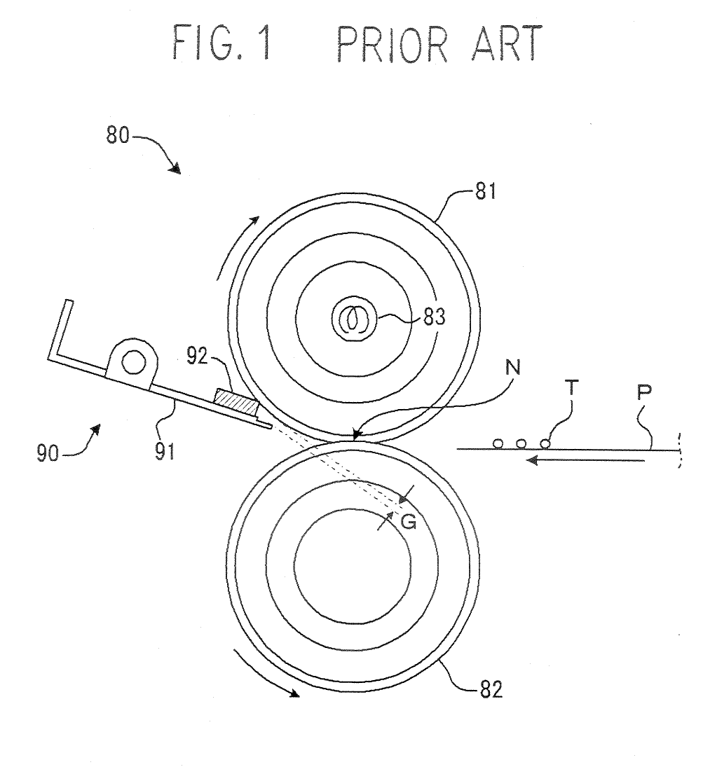

As described above, Japanese Unexamined Patent Application Publication H6-149114 proposes a fixing apparatus in which a tip end of separating means is disposed at a remove from the surface of a fixing roller. As shown in FIG. 1, a fixing apparatus 80 comprises a fixing member constituted by a fixing roller 81, and a pressure member constituted by a pressure roller 82, which is pressed against the fixing roller 81. The respective peripheral surfaces of the rollers 81, 82 are pressed together to form a nip portion N. A tip end portion of a separating claw 91 of separating means 90 is provided with a contact member 92, and by bringing the contact member 92 into contact with the peripheral surface of the fixing roller 81, a gap (an interval) G is formed between the tip end of the separating claw 91 and the surface of the fixing roller 81 so that the tip end of the fixing claw is separated from the surface of the fixing roller.

As described above, however, in this conventional fixing apparatus, the contact member 92 contacts the peripheral surface of the fixing roller 81, and therefore the surface of the fixing roller 81 may be damaged. When the surface of the fixing member is damaged, a track mark corresponding to the damage is formed on the toner image that passes through the nip portion, and as a result, the image quality of the fixed toner image deteriorates. Moreover, it is not easy to set the interval G to the correct value.

Each embodiment of the present invention, which is designed to solve the problems in the background art described above, will now be described on the basis of the drawings.

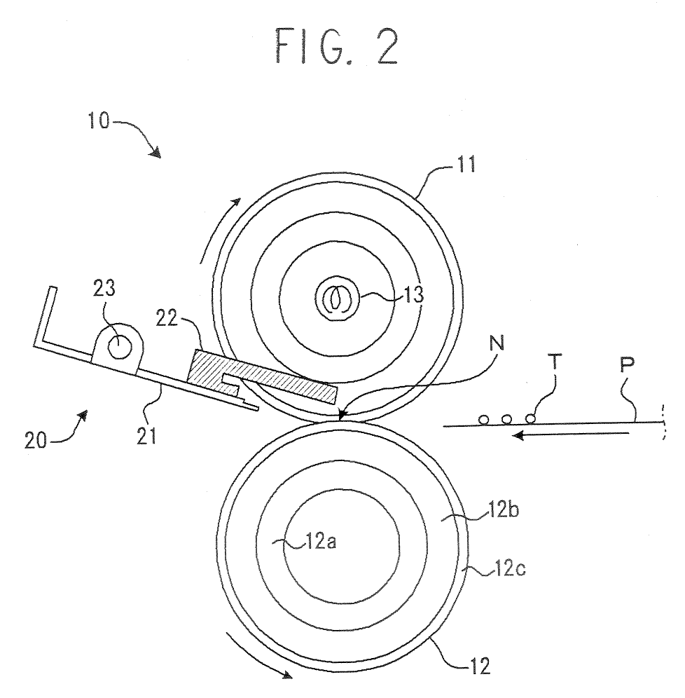

FIG. 2 shows the structure of the main parts of a first embodiment of the fixing apparatus according to the present invention. A fixing apparatus 10 shown in the drawing comprises a fixing roller 11 serving as a fixing member, and a pressure roller 12 serving as a pressure member that is pressed against the fixing roller. The respective peripheral surfaces of the rollers 11, 12 are pressed together to form a nip portion N. The fixing roller 11 and pressure roller 12 are formed in a cylindrical shape having a hollow interior. The fixing roller 11 rotates in the clockwise direction of the drawing, while the pressure roller 12 rotates in the counter-clockwise direction of the drawing. Heating means 13 such as a halogen heater, which are controlled by temperature controlling means not shown in the drawing, are disposed in the interior of the fixing roller 11, and by controlling electrification of the heating means 13, the nip portion N is heated to a suitable temperature for fixing. Transfer paper P serving as a recording medium carrying an unfixed toner image T is conveyed to the nip portion N as shown by the arrow, with the toner image carrying surface facing the fixing roller 11, and at this time, the toner image T is fixed onto the transfer paper P by the application of heat and pressure.

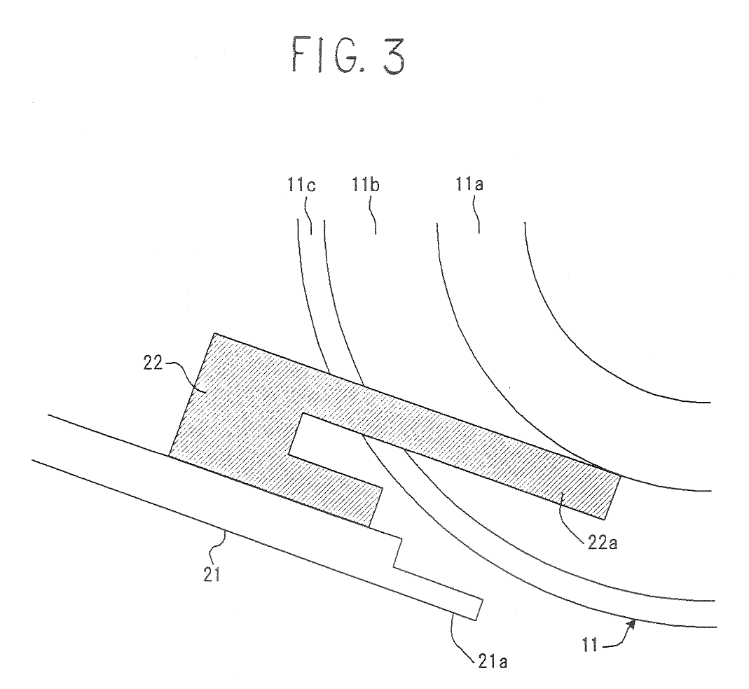

As shown by the enlargement in FIG. 3, the fixing roller 11 is constituted by a core metal 11a serving as a roller structural body, an elastic layer 11b laminated onto the core metal, and a mold release layer 11c forming the outermost layer. In this embodiment, the core metal 11a extends further outward (in an axial direction) than the elastic layer 11b and mold release layer 11c such that the core metal 11a protrudes outward (on both sides of the axial direction) from the end surfaces of the elastic layer 11b and mold release layer 11c. A tip end portion 22a of a spacer 22 of separating means 20 to be described below contacts the peripheral surface of the protruding portion of the core metal 11a.

Returning to FIG. 2, the separating means 20 are disposed on an outlet side of the nip portion N. The separating means 20 comprise a separating claw 21 supported rotatably by a shaft 23, and the spacer 22, which is mounted in the vicinity of the tip end portion of the separating claw 21. The tip end of the separating claw 21 is oriented toward the outlet of the nip portion N, and as shown by the enlargement in FIG. 3, the separating claw tip end portion 21a is provided close to the peripheral surface of the fixing roller 11. Note that the tip end portion 21a of the separating claw 21 is biased in the direction of the peripheral surface of the fixing roller 11 by biasing means not shown in the drawing.

As shown by the enlargement in FIG. 3, the spacer 22 has a C-shaped cross-section with one side (the side on the fixing roller 11 side) longer than the other, and a tip end 22a of the long side portion contacts the (protruding portion of the) core metal 11a of the fixing roller 11. By having the tip end 22a of the spacer 22 in the separating means 20 contact the core metal 11a, the gap, or in other words the distance, between the tip end of the separating claw 21 and the peripheral surface of the fixing roller 11 is set at a predetermined magnitude, and the position of the separating claw 21 is determined according to the core metal 11a of the fixing roller 11. Note that the separating claw 21 extends in the axial direction of the fixing roller 11, and spacers 22 are mounted on both end portions of the separating claw 21 (the two end portions in the lengthwise direction, i.e. the axial direction of the fixing roller). Thus, the spacers 22 respectively contact the protruding portions of the core metal 11a on either side of the fixing roller.

In the fixing apparatus 10 of this embodiment, the gap between the separating claw 21 and the fixing roller 11 is managed by having the spacer 22 attached to the separating claw 21 contact the core metal 11a of the fixing roller, and therefore the gap between the separating member and fixing member can be managed appropriately over the long term. Moreover, management of the gap can be performed easily, using a simple structure, and at low cost. Since the gap between the separating member and fixing member can be managed appropriately, the recording medium can be prevented from coiling around the surface of the fixing member (in this embodiment, the fixing roller 11) effectively, and since neither the separating claw nor any other contact member comes into contact with the peripheral surface of the fixing member, the surface of the fixing member is not damaged.

Incidentally, in the fixing apparatus 10 of this embodiment, the hardness of the outer peripheral surface of the pressure roller 12 is set to a higher value than the hardness of the outer peripheral surface of the fixing roller 11. As a result, the nip portion N is formed in a convex form in which the peripheral surface of the fixing roller 11 is indented, as shown in FIG. 2. When a recording material (transfer paper or the like) passes through this convex nip portion, the tip end portion of the recording material is discharged from the outlet portion of the nip portion in a tangential direction of the pressure roller, i.e. in a direction that moves away from the peripheral surface of the fixing roller 11, and therefore the upper surface of the recording material is less likely to become adsorbed to and coiled around the peripheral surface of the fixing roller 11, even when toner exists on the upper surface of the recording material. Moreover, in this embodiment the separating means 20 are provided as described above, and therefore recording material that attempts to coil around the fixing roller 11 can be peeled away. Hence, the recording material can be prevented from coiling around the fixing roller 11 even more reliably. The recording material can be prevented from coiling around the fixing roller 11 particularly reliably during image formation using color toner, and therefore gloss unevenness caused by an increase in gloss occurring when a color toner image coils around the fixing roller 11 and is subsequently peeled away can be prevented. Thus, the fixing apparatus 10 can be used favorably as a fixing apparatus for a color image forming apparatus.

A specific structural example of the fixing apparatus 10 will now be described. Note that the numerical values of the various members cited here are merely examples, and may be set appropriately in accordance with the present invention.

In this embodiment, the outer diameter of the fixing roller 11 is 35 mm. The core metal 11a has an outer diameter of 31 mm, and is formed from a hollow roller made of 1.5 mm thick aluminum. The elastic layer 11b is formed from silicone rubber having a thickness of 2 mm, and the mold release layer 11c is formed from a PFA tube having a thickness between 10 μm and 30 μm. By providing the mold release layer, adhesion of the recording material to the surface of the fixing roller 11 caused by the adhesive strength of the toner can be suppressed.

The pressure roller 12 is constituted by a core metal 12a made from a hollow iron roller having an outer diameter of 31 mm and a thickness of 1.5 mm, an elastic layer 12b laminated onto the outer peripheral surface thereof, and a mold release layer 12c laminated onto the outer peripheral surface thereof. The elastic layer 12b is formed from silicone rubber having a layer thickness of 2 mm, and the mold release layer 12c is formed from a PFA tube having a layer thickness between 10 μm and 30 μm.

In this embodiment, the surface hardness of the fixing roller 11 is set at 5, for example, according to a JIS-A hardness meter, and the surface hardness of the pressure roller 12 is set at 15, for example, according to the same JIS-A hardness meter. Since the pressure roller 12 is harder than the fixing roller 11, the mold release layer and elastic layer of the fixing roller 11 deform elastically when the pressure roller 12 digs into the surface of the fixing roller 11, and therefore the nip portion N is formed in accordance with the outer shape of the pressure roller.

The separating means may be constituted in any appropriate form, but in this embodiment, the separating means 20 comprise the plate-form or sheet-form separating claw 21, and the tip end portion of the separating claw is preferably formed in a sharp edged form or a thin plate form, according to necessity. In the separating means 20 of this embodiment, the tip end portion 21a of the separating claw 21 is formed in a thin plate form that is thinner than the main body part.

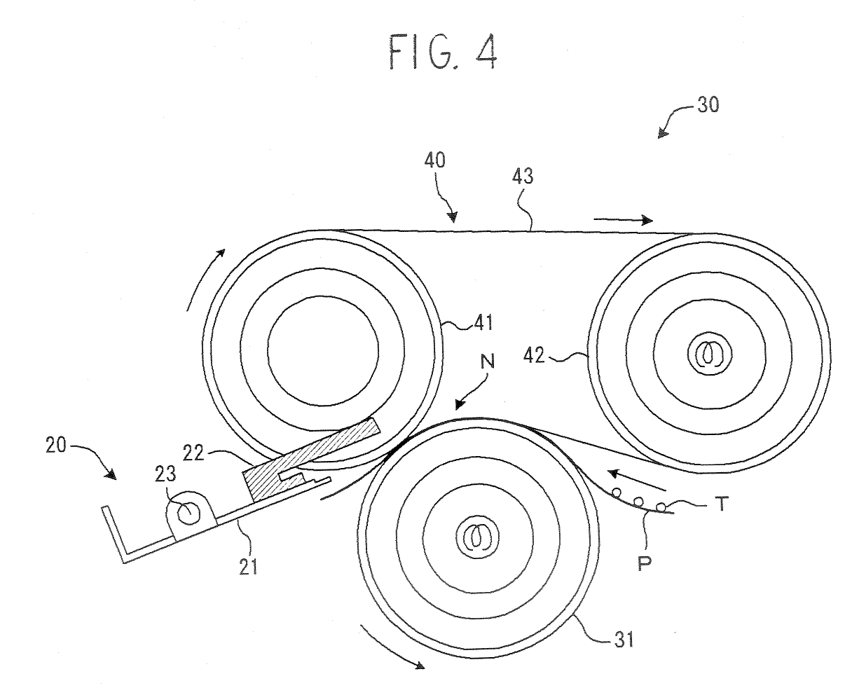

FIG. 4 shows the structure of the main parts of a second embodiment of the fixing apparatus.

A fixing apparatus 30 shown in FIG. 4 comprises a fixing member 40 and a pressure roller 31. The fixing member 40 is constituted by a fixing roller 41, a guide roller 42 serving as a heating roller, and an endless fixing belt 43 wrapped around the fixing roller 41 and guide roller 42. The pressure roller 31 has a built-in heater, and is pressed against the fixing roller 41 via the fixing belt 43. In the fixing apparatus 30 of this embodiment, the pressure roller 31 presses against the fixing belt 43, which is wrapped around the fixing roller 41 and guide roller 42 serving as two guide members, thereby forming the nip portion N.

The pressure roller 31 is rotated in the counter-clockwise direction of the drawing, while the fixing roller 41 and guide roller 42 are rotated in the clockwise direction of the drawing. As a result, the fixing belt 43 is driven to travel in the clockwise direction of the drawing, as shown by the arrows in the drawing. When the endless fixing belt 43 travels in this manner, the fixing roller 41 and guide roller 42 guide the fixing belt 43, and the pressure roller 31 forms the nip portion N in conjunction with the fixing roller 41. Meanwhile, the guide roller 42 functions as a tension roller for applying tension to the fixing belt 43.

Furthermore, in this embodiment heating means such as a halogen heater are disposed in the respective interiors of the pressure roller 31 and the guide roller 42, and by means of these heating means, the fixing belt 43 and pressure roller 31 are heated. By controlling electrification of the respective heating means using temperature controlling means, not shown in the drawing, the nip portion N is heated to a suitable temperature for fixing. The transfer paper P serving as the recording medium carrying the unfixed toner image T is conveyed to the nip portion N with the toner image carrying surface facing the fixing belt 43, as shown by the arrow, and at this time, the toner image T is fixed onto the transfer paper P through the application of heat and pressure.

Note that the pressure roller 31 and guide roller 42 may have a basically identical structure to the fixing roller 11 of the first embodiment described above, and that the fixing roller 41 may have a basically identical structure to the pressure roller 12 of the first embodiment described above. However, in the pressure roller 31 and guide roller 42 of this embodiment, the core metal end portions do not protrude from the end surfaces of the elastic layer and mold release layer, and hence the roller end surfaces are aligned. Similarly to the fixing roller 11 of the first embodiment, the fixing roller 41 is structured such that the two side end portions of the core metal serving as the roller structural body protrude from the end surfaces of the elastic layer and mold release layer.

The separating means 20 are disposed on the outlet side of the nip portion N. After passing through the nip portion N, the transfer paper P is conveyed under the guidance of the separating means 20 such that when the transfer paper P attempts to coil around the fixing roller 41 and fixing belt 43, it is separated from the surfaces thereof by the separating means 20, which are provided in a state of non-contact with the surfaces of the fixing roller and fixing belt.

The separating means 20 are identical to the separating means of the first embodiment described above, and the tip end 22a of the spacer 22 is in contact with the core metal peripheral surface that protrudes on both sides of the fixing roller 41. Hence, the gap, or in other words the distance, between the tip end of the separating claw 21 and the peripheral surface of the fixing roller 41 is set at a predetermined magnitude, and the position of the separating claw 21 is determined according to the core metal of the fixing roller 41. Since the gap between the separating claw 21 and the fixing roller 41 is managed reliably, the gap between the separating claw 21 and the fixing belt 43 is also maintained reliably, and the fixing belt 43 is not damaged by the separating member.

Note that the relationship between the hardness of the respective outer peripheral surfaces of the fixing roller 41 and pressure roller 31 in this embodiment is identical to that of the first embodiment, i.e. fixing roller 41<pressure roller 31, whereby the pressure roller 31 is harder than the fixing roller 41.

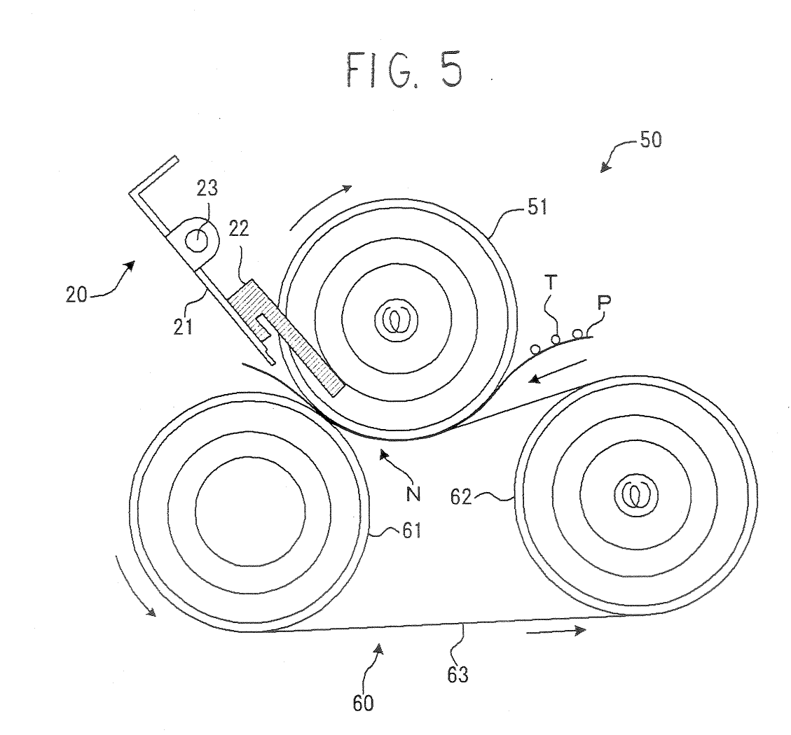

FIG. 5 shows the structure of the main parts of a third embodiment of the fixing apparatus.

A fixing apparatus 50 shown in FIG. 5 comprises a fixing roller 51 serving as a fixing member, and a pressure member 60. The pressure member 60 is constituted by a pressure roller 61, a guide roller (tension roller) 62, and an endless pressure belt 63 wrapped around the pressure roller 61 and guide roller 62. The pressure roller 61 is pressed against the fixing roller 51 via the pressure belt 63. In the fixing apparatus 50 of this embodiment, the pressure belt 63 wrapped around the pressure roller 61 and guide roller 62, which serve as two guide members, is pressed against the fixing roller 51, thereby forming the nip portion N.

The fixing roller 51 is rotated in the clockwise direction of the drawing, while the pressure roller 61 and guide roller 62 are rotated in the counter-clockwise direction of the drawing. As a result, the pressure belt 63 is driven to travel in the counter-clockwise direction of the drawing, as shown by the arrows in the drawing. When the endless pressure belt 63 travels in this manner, the pressure roller 61 and guide roller 62 guide the pressure belt 63, and the fixing roller 51 forms the nip portion N in conjunction with the pressure roller 61. Meanwhile, the guide roller 62 functions as a tension roller for applying tension to the pressure belt 63.

Furthermore, in this embodiment heating means such as a halogen heater are disposed in the respective interiors of the fixing roller 51 and the guide roller 62, and by means of these heating means, the fixing roller 51 and guide roller 62 (pressure belt 63) are heated. By controlling electrification of the respective heating means using temperature controlling means, not shown in the drawing, the nip portion N is heated to a suitable temperature for fixing. The transfer paper P serving as the recording medium carrying the unfixed toner image T is conveyed to the nip portion N with the toner image carrying surface facing the fixing roller 51, as shown by the arrow, and at this time, the toner image T is fixed onto the transfer paper P through the application of heat and pressure.

Note that the fixing roller 51 and pressure roller 61 may be formed identically to the fixing roller 11 and pressure roller 12 of the first embodiment described above. Accordingly, the fixing roller 51 is structured such that the two side end portions of the core metal protrude from the end surfaces of the elastic layer and mold release layer. The core metal of the pressure roller 61 does not protrude, and the roller end surfaces are aligned. Meanwhile, the guide roller 62 may be formed identically to the guide roller 42 of the second embodiment described above. Hence, the guide roller 62 is basically identical to the fixing roller 11 of the first embodiment described above, although the core metal end portions do not protrude from the end surfaces of the elastic layer and mold release layer, and the roller end surfaces are aligned.

The separating means 20 are disposed on the outlet side of the nip portion N. After passing through the nip portion N, the transfer paper P is conveyed under the guidance of the separating means 20 such that when the transfer paper P attempts to coil around the fixing roller 51, it is separated from the surface of the fixing roller by the separating means 20, which are provided in a state of non-contact with the fixing roller surface. The separating means 20 are identical to the separating means of the first embodiment described above, and the tip end 22a of the spacer 22 is in contact with the core metal peripheral surfaces that protrude on either side of the fixing roller 51. Hence, the gap, or in other words the distance, between the tip end of the separating claw 21 and the peripheral surface of the fixing roller 51 is set at a predetermined magnitude, and the position of the separating claw 21 is determined according to the core metal of the fixing roller 51.

Note that the relationship between the hardness of the respective outer peripheral surfaces of the fixing roller 51 and pressure roller 61 in this embodiment is identical to that of the first embodiment, i.e. fixing roller 51<pressure roller 61, whereby the pressure roller 61 is harder than the fixing roller 51.

In the fixing apparatuses 30, 50 of the second and third embodiments described above, the transfer paper P is prevented from coiling around the fixing roller 41 and fixing belt 43 (second embodiment) or the fixing roller 51 (third embodiment) after passing through the nip portion N. Further, the gap between the separating means 20 and the fixing roller 41 and fixing belt 43 (second embodiment) or between the separating means 20 and the fixing roller 51 (third embodiment) is maintained reliably, enabling an improvement in the image quality of the fixed toner image. Moreover, damage to the fixing roller 41, fixing belt 43, or fixing roller 51 can be prevented, enabling an extension in the life of these members.

Particularly during image formation using color toner, it is possible to prevent gloss unevenness caused by an increase in gloss occurring when the toner image part of the paper (recording material) becomes adsorbed to and coiled around one of the members and is then peeled away, and therefore favorable multicolor and full color images can be obtained.

To describe specific structural examples of the fixing belt and pressure belt in the second and third embodiments, the fixing belt or pressure belt 43, 63 is formed by laminating silicone rubber having a thickness of 0.2 mm and a hardness of 30 according to a JIS-A hardness meter onto a 50 μm thick polyimide resin base, and then applying PFA thereon to a thickness of 20 μm as the mold release layer, for example.

Further, the nip portion N of the fixing apparatus 30 according to the second embodiment is formed by a first nip part in which the pressure roller 31 contacts only the fixing belt 43 in sites not facing the fixing roller 41, and a second nip part in which the pressure roller 31 contacts the fixing roller 41 via the fixing belt 43. Thus, the nip portion N can be formed over a wide range in the rotation direction of the fixing belt, and as a result, the pressing force between the pressure roller 31 and fixing belt 43 can be made comparatively small, and the correct temperature of the nip portion N can be reduced.

Similarly, the nip portion N of the fixing apparatus 50 according to the third embodiment is formed by a first nip part in which the fixing roller 51 contacts only the pressure belt 63 in sites not facing the pressure roller 61, and a second nip part in which the fixing roller 51 contacts the pressure roller 61 via the pressure belt 63. Thus, the nip portion N can be formed over a wide range in the rotation direction of the pressure belt, and as a result, the pressing force between the fixing roller 51 and pressure belt 63 can be made comparatively small, and the correct temperature of the nip portion N can be reduced.

Furthermore, in the fixing apparatuses 30, 50 of the second and third embodiments described above, heaters are provided respectively in the comparatively thin elastic layer (in these embodiments, the thickness is set at 2 mm) of the pressure roller 31, the fixing roller 51, and the guide rollers 42, 62. Moreover, the thin, low thermal capacity fixing belt or pressure belt 43, 63 is used, and the fixing belt or pressure belt is heated from both sides by rollers having a comparatively thin elastic layer (the pressure roller 31, fixing roller 51, and guide rollers 42, 62), and therefore the time required for the fixing belt or pressure belt 43, 63 to rise to the set fixing temperature can be shortened.

Further, a thin plate made of a heat-resistant resin or metal, for example a member formed by coating the surface of a 0.1 mm thick polyimide sheet with a fluorine resin, may be used as the sheet-form separating member of each of the embodiments described above (in these embodiments, the separating claw 21 of the separating means 20). Furthermore, when a sheet or plate material having a thickness of 0.2 mm or more is used as the separating member, the strength thereof increases, which is effective in maintaining a constant interval between the separating means and the fixing member or pressure member.

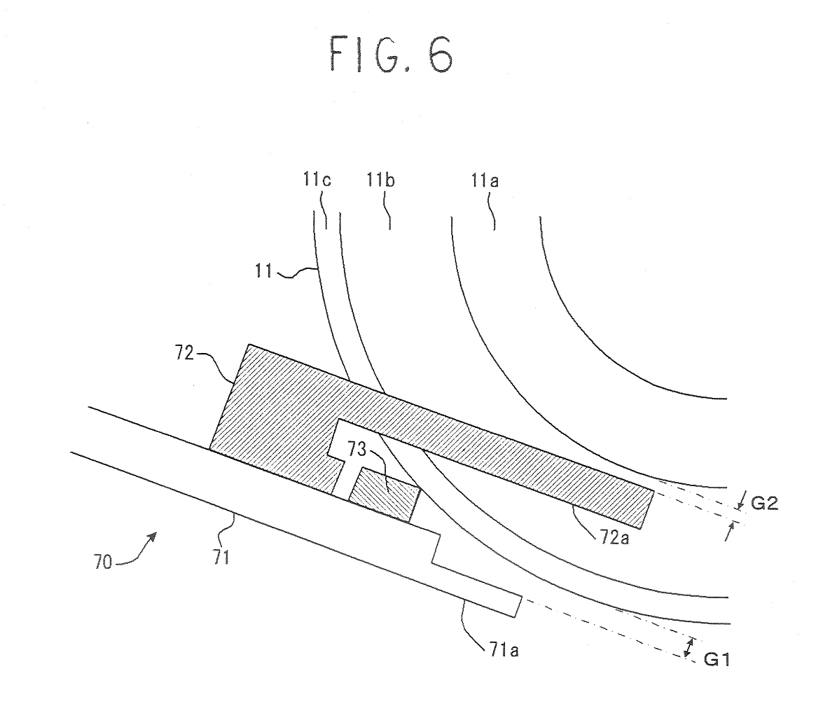

FIG. 6 shows the structure of an example of separating means having a contact member that contacts the peripheral surface of the fixing roller, and in particular shows the structure in the vicinity of a tip end portion thereof.

Separating means 70 shown in FIG. 6 are provided with a contact member 73 on the roller side (in the illustrated example, the fixing roller 11 side) near the tip end portion of a separating claw 71. The contact member 73 is attached to the separating claw 71 at both end portions in the roller width direction (the axial direction of the fixing roller 11), and contacts the roller surface outside the region of the fixing roller 11 through which the paper passes. By having the contact member 73 contact the roller surface, a gap is formed between a tip end portion 71a of the separating claw 71 and the surface of the fixing roller 11. In this embodiment, the gap, or in other words the distance, between the tip end portion 71a of the separating claw 71 and the fixing roller 11 is set at G1 by means of the contact member 73. Note that the fixing roller 11 is identical to the fixing roller 11 of the first embodiment described above, and hence the core metal 11a protrudes to the outside (in the axial direction) from both sides of the elastic layer 11b and the mold release layer 11c.

A spacer 72 is attached to the fixing roller 11 side of the separating claw 71. A tip end portion 72a of the spacer 72 extends greatly forward so as to be positioned further forward than the tip end portion 71a of the separating claw 71. Note, however, that the tip end portion 72a of the spacer 72 does not contact the core metal 11a of the fixing roller 11, and hence a gap G2 is formed between the tip end portion 72a and the core metal 11a. The gap G2 and the gap G1 have a relationship of G2<G1. In other words, the distance between the separating claw tip end and the fixing roller surface is set to be larger than the distance between the tip end of the spacer 72 and the core metal. Note that here, the contact member 73 and spacer 72 are depicted as separate members for ease of understanding, but the contact member 73 and spacer 72 may be formed integrally.

With separating means such as the separating means 70 of this embodiment, in which a contact member provided on the separating claw is brought into contact with the roller surface such that the tip end of the separating claw is removed from the roller surface (the separating claw is maintained in a state of non-contact relative to the roller), the rubber (the elastic layer and mold release layer) on the roller surface which contacts the contact member deteriorates over time as the fixing apparatus is used, causing the gap between the separating claw tip end and the roller to decrease from its initial state such that ultimately, the roller surface may be damaged by the tip end of the separating claw.

With the separating means 70 of this embodiment, however, the spacer 72 is provided as described above. Therefore, even if the gap G1 between the separating claw tip end 71a and the fixing roller surface decreases due to deterioration of the rubber on the surface layer of the fixing roller 11, the spacer 72 contacts the roller core metal 11a before the separating claw tip end 71a contacts the surface of the fixing roller because the spacer 72 is provided in close proximity to the roller core metal 11a via the gap G2, which is smaller than the gap G1. Hence, even when the rubber on the surface layer of the fixing roller deteriorates, a minimum interval of “G1-G2” is maintained between the separating claw tip end 71a and the fixing roller surface, and therefore contact between the separating claw tip end 71a and the roller surface is prevented. As a result, the separating claw tip end is reliably prevented from damaging the roller surface.

Note that in the example described here, the separating means 70 are provided on the fixing roller 11, but similarly to the example shown in FIG. 4, the separating means 70 of this embodiment may be provided on a roller around which a fixing belt is wrapped in a structure employing a fixing belt.

Incidentally, in each of the fixing apparatuses of the embodiments described above, a mold release agent such as silicone oil may be applied to the fixing roller, pressure roller, pressure belt, fixing belt, and so on, which serve as the fixing member or the pressure member, to prevent the recording material from coiling around these members even more reliably.

However, when oil or another mold release agent is applied, the oil may adhere to the recording material, thereby soiling the recording material. Moreover, the maintenance required to apply the oil is complicated, and an application member is required to apply the oil, thereby increasing the cost of the fixing apparatus.

Hence, by employing a wax-containing toner as the toner such that the toner image is formed by toner containing at least resin, a coloring agent, and wax, so-called oilless image formation, excluding the application of a mold release agent, can be achieved. As a result, oil adhesion to the recording material can be prevented, and increases in maintenance costs and the cost of the apparatus can be avoided.

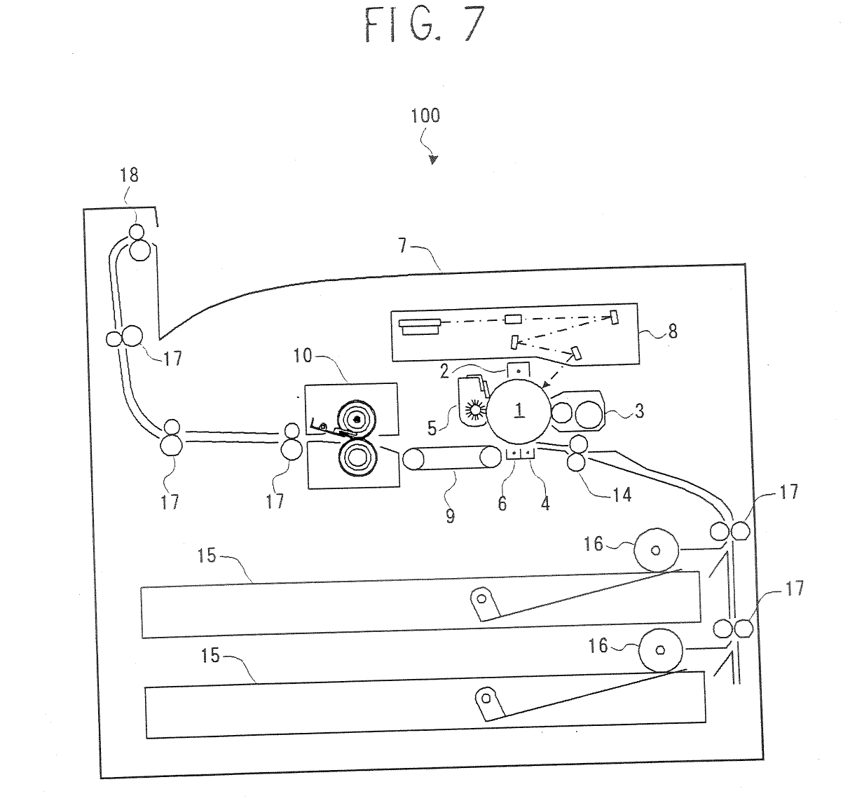

Finally, an example of an image forming apparatus to which the fixing apparatus according to each of the embodiments of the present invention can be attached will be described with reference to FIG. 7.

A printer 100 serving as an image forming apparatus shown in FIG. 7 is provided with a discharge tray 7 on an upper surface thereof. A laser writing unit 8 is disposed below the discharge tray 7, and an image creation unit centering on a photosensitive drum 1 is provided therebelow. Various devices required in an electrophotographic process, such as an electrifier 2, a developing apparatus 3, a transfer apparatus 4, a cleaning apparatus 5, and a neutralizer, are disposed on the periphery of the photosensitive drum 1. A separation charger 6 is disposed adjacent to a transfer charger 4 serving as the transfer apparatus. The fixing apparatus 10 is disposed to the left of the image creation unit in the drawing, and the photosensitive drum 1 communicates with the fixing apparatus 10 via a conveyor belt 9. Note that here, the fixing apparatus 10 of the first embodiment is used as the fixing apparatus, but the fixing apparatuses of any of the embodiments described above may be used.

The laser writing unit 8 is constituted by a laser output unit, an imaging lens, a mirror, and so on, and comprises a laser diode as a laser light source, and a rotary multi-surface mirror (polygon mirror) that is rotated at a constant high speed by a motor. Laser light emitted by the laser output unit is polarized by the polygon mirror rotating at a constant speed, passes through the imaging lens, and is then turned back by the mirror so as together and form an image on the photosensitive body surface of the image creation unit.

Two paper feeding cassettes 15, 15 are provided in stages in the lower portion of the apparatus, and paper feeding means 16, 16 are provided to correspond to each paper feeding cassette. Conveyance rollers 17 are disposed appropriately in various locations on a paper conveyance path extending from the paper feeding cassettes 15 to the discharge tray 7. Paper conveyed from the paper feeding cassettes 15 by the paper feeding means 16 is conveyed upward by the conveyance rollers 13 to a resist roller 14.

A brief description of a print operation performed by the printer 100 structured as described above will now be provided.

The laser output unit of the laser writing unit 8 is driven on the basis of image data transmitted from an external device such as a personal computer, whereby the photosensitive drum 1 is irradiated with laser light from the writing unit 8 such that an electrostatic latent image is formed on the surface of the photosensitive drum 1. Toner is then applied to the electrostatic latent image by the developing apparatus 3, whereby the electrostatic latent image is visualized as a toner image.

Meanwhile, paper is fed from one of the paper feeding cassettes 15, 15 and conveyed to the resist roller 14. The paper is then conveyed to the transfer unit by the resist roller 14 in synchronization with the toner image on the photosensitive drum 1. The toner image on the photosensitive drum 1 is then transferred onto the paper by the transfer apparatus 4, whereupon the paper is separated from the photosensitive body by the separation charger 6. The paper carrying the toner image is then conveyed by the conveyor belt 9 to the fixing apparatus 10, where the toner image is fixed to the paper through the application of heat and pressure. Once the toner image has been fixed, the paper is conveyed by the conveyance roller 17 and discharged by a discharge roller 18 onto the discharge tray 7 on the upper surface of the apparatus.

Note that instead of a charger type electrifier for charging the surface of the photosensitive drum 1 uniformly, a type of electrifier that contacts the photosensitive body surface, for example a charging roller, may be employed. Further, instead of a charger type transfer apparatus, a type of transfer apparatus that contacts the photosensitive body surface, for example a transfer roller or a transfer belt, may be employed. Furthermore, instead of the laser scanning system used in this embodiment, an aligner constituted by an LED (light-emitting diode) array and an imaging element, for example, may be employed as a writing unit.

The present invention was described above using illustrated embodiments, but the present invention is not limited to these embodiments.

For example, the structure of the fixing roller and pressure roller serving respectively as the fixing member and pressure member may be modified appropriately, and the structure, material, thickness, and so on of each layer thereof are arbitrary. Further, heating means may be provided in the interior of the pressure roller. Also, the heating means for heating the fixing roller are not limited to the interior of the roller, and may be provided on the exterior of the roller. Moreover, an arbitrary heating method, such as an induction heating method or a surface heating (resistance heating) method, may be employed. The structure, material, and so on of the fixing belt/pressure belt are also arbitrary. The number of members supporting the fixing belt/pressure belt, the manner in which the belt is hung, and so on are also arbitrary. The structure of the separating means may also be modified appropriately within the scope of the present invention.

The structure of the various parts of the image forming apparatus is also arbitrary. Moreover, the image forming apparatus is not limited to the monochrome apparatus illustrated in the drawings, and the present invention may also be applied to a color apparatus or full color apparatus employing a plurality of colors. The structure of the image creation unit is also arbitrary, and an intermediate transfer method, a tandem method, or another method may be employed. The image forming apparatus is not limited to a printer, and may be a copier, a facsimile, or a compound device having a plurality of functions.

The fixing apparatus according to the present invention has the following features.

(1) The separating means comprise a separating member and a spacer attached to the separating member, and by bringing the spacer into contact with the structural body of the fixing member, the gap between the separating member and the fixing member is maintained, enabling long-term, appropriate management of the gap between the separating member and fixing member. Hence, the recording material can be prevented from coiling around the surface of the fixing member, and the surface of the fixing member is not damaged. Moreover, management of the gap between the separating member and fixing member can be performed easily, at low cost, and using a simple structure.

(2) The separating member can be prevented from contacting the fixing roller using a simple structure.

(3) When a belt fixing method is employed, the separating member can be prevented from contacting the fixing belt using a simple structure.

(4) By bringing the spacer into contact with the structural body of the fixing member at both end portions of the separating member, the separating member can be supported from both sides in a well-balanced fashion, and the separating member can be prevented from contacting the fixing roller reliably.

(5) The spacer contacts a protruding portion protruding on the outer side of the elastic layer, and therefore the separating member can be separated from the fixing member reliably using a simple structure.

(6) The tip end side of the separating member is biased in a direction approaching the fixing member, and therefore the recording material can be separated reliably at all times.

(7) The tip end portion of the separating member is formed in a thin plate form or a sharp edged form, and therefore the recording material can be separated even more reliably.

(8) The fixing nip can be formed over a wide range in the circumferential direction of the fixing belt, and therefore the fixing performance can be improved. Moreover, the pressing force between the fixing member and the pressure member can be made comparatively small, and the set fixing temperature can be reduced.
(9) The fixing nip can be formed over a wide range in the circumferential direction of the pressure belt, and therefore the fixing performance can be improved. Moreover, the pressing force between the fixing member and the pressure member can be made comparatively small, and the set fixing temperature can be reduced.
   (10) Contact between the separating member and fixing member can also be prevented reliably in a fixing apparatus having a contact member, in which the separating member is separated from the fixing member. As a result, damage to the surface of the fixing member caused by the separating member can be prevented.
   (11) The hardness of the outer layer portion of the pressure member is greater than the hardness of the outer layer portion of the fixing member, and therefore a nip portion that is indented on the fixing member side is formed such that the recording material is discharged in a direction leading away from the fixing member. As a result, the recording material is less likely to be adsorbed onto the surface of the fixing member, and the recording material can be separated more reliably.
   (12) Since there is no need to coat the fixing member and pressure member with mold release oil, a reduction in cost and an improvement in maintainability can be achieved. Moreover, soiling of the recording material by the oil can be eliminated.
   (13) By preventing the recording material from coiling around the surface of the fixing member, paper jams in the fixing apparatus can be prevented. Further, it is possible to realize an image forming apparatus comprising a fixing apparatus in which coiling of the recording material is prevented by managing the gap between the separating member and fixing member in the fixing apparatus permanently and appropriately.
   (14) Gloss unevenness caused by an increase in gloss occurring when the toner image part of a sheet of paper (recording material) becomes adsorbed to and coiled around the fixing member and is then peeled away during image formation using color toners in a plurality of colors can be prevented, and therefore favorable multicolor images and full color images can be obtained.
   (15) Since there is no need to coat the fixing member and pressure member of the fixing apparatus with mold release oil, a reduction in cost and an improvement in maintainability can be achieved. Moreover, soiling of the recording material by the oil can be eliminated.

Various modifications will become possible for those skilled in the art after receiving the teachings of the present disclosure, without departing from the scope thereof.

What is claimed is:

1. A fixing apparatus having a fixing member that is heated by a heat source and a pressure member that is pressed against the fixing member, in which a recording material carrying an unfixed image is passed between the fixing member and the pressure member to fix the unfixed image on the recording material, the fixing apparatus further comprising separating means for separating the recording material from the fixing member following fixing,
wherein the separating means comprise a separating member and a spacer attached to the separating member, and
a gap between the separating member and the fixing member is maintained by bringing the spacer into contact with a structural body of the fixing member.

2. The fixing apparatus as claimed in claim 1, wherein the fixing member is a fixing roller, and the structural body is a roller core metal.

3. The fixing apparatus as claimed in claim 1, wherein the fixing member is an endless fixing belt, and the structural body is a core metal of a support roller for supporting the fixing belt.

4. The fixing apparatus as claimed in claim 3, wherein the fixing belt is wrapped around a plurality of guide rollers including the support roller, and the pressure member is pressed against at least one of the guide rollers via the fixing belt.

5. The fixing apparatus as claimed in claim 1, wherein the spacer is disposed at both end portions of the separating member in an orthogonal direction to a paper conveyance direction of the fixing apparatus such that the spacer contacts the structural body at both end portions of the separating member.

6. The fixing apparatus as claimed in claim 3, wherein the fixing member or the support roller comprises an elastic layer, and the structural body comprises a protruding portion which protrudes outward from end portions of the elastic layer such that the spacer contacts the protruding portion.

7. The fixing apparatus as claimed in claim 1, wherein the separating means are biased in a direction for causing a tip end side of the separating member to approach the fixing member.

8. The fixing apparatus as claimed in claim 1, wherein a tip end portion of the separating member is formed in a thin plate form or a sharp edged form.

9. The fixing apparatus as claimed in claim 1, wherein the pressure member is constituted by a plurality of guide rollers and an endless pressure belt wrapped around the plurality of guide rollers, and the fixing member is pressed against at least one of the guide rollers via the pressure belt.

10. The fixing apparatus as claimed in claim 1, wherein the separating means comprise a contact member which contacts the surface of the fixing member to separate the separating member from the fixing member,
the spacer is provided so as not to contact the structural body, and
when a gap between the separating member and the fixing member is G1 and a gap between the spacer and the structural body is G2, G1>G2 is satisfied.

11. The fixing apparatus as claimed in claim 1, wherein, when a hardness of an outer layer portion of the fixing member is B1 and a hardness of an outer layer portion of the pressure member is B2, B1<B2 is satisfied.

12. The fixing apparatus as claimed in claim 1, wherein the unfixed image is formed by a toner containing at least a resin, a coloring agent, and a wax.

13. An image forming apparatus comprising a fixing apparatus having a fixing member that is heated by a heat source and a pressure member that is pressed against the fixing member, in which a recording material carrying an unfixed image is passed between the fixing member and the pressure member to fix the unfixed image on the recording material, the fixing apparatus further comprising separating means for separating the recording material from the fixing member following fixing,
wherein the separating means comprise a separating member and a spacer attached to the separating member, and
a gap between the separating member and the fixing member is maintained by bringing the spacer into contact with a structural body of the fixing member.

14. The image forming apparatus as claimed in claim 13, wherein the image forming apparatus is a color image forming apparatus for forming an image using toner of a plurality of colors.

15. An image forming method for causing a recording material to carry an image formed by a toner containing at least a resin, a coloring agent, and a wax, and fixing the toner image carried on the recording material onto the recording material using a fixing apparatus,
wherein the fixing apparatus comprises a fixing member that is heated by a heat source and a pressure member that is pressed against the fixing member, and fixes an unfixed image on the recording material carrying the unfixed image by passing the recording material between the fixing member and the pressure member, the fixing apparatus further comprising separating means for separating the recording material from the fixing member following fixing,
the separating means comprise a separating member and a spacer attached to the separating member, and
a gap between the separating member and the fixing member is maintained by bringing the spacer into contact with a structural body of the fixing member.
